(19) United States
(12) Patent Application Publication
(10) Pub. No.: US 2016/0184710 A1
(43) Pub. Date: Jun. 30, 2016

(54) Secure Computing for Virtual Environment and Interactive Experiences

(71) Applicant: Wrafl, Inc., Everett, WA (US)

(72) Inventors: Robert L. Zerr, Marysville, WA (US); Phillip G. Tapia, Lake Stevens, WA (US); Scott M. Davidson, Monroe, WA (US); James V. Mischel, JR., Seattle, WA (US)

(21) Appl. No.: 14/980,803

(22) Filed: Dec. 28, 2015

Related U.S. Application Data
(60) Provisional application No. 62/098,757, filed on Dec. 31, 2014.

(51) Int. Cl. A63F 13/71; H04L 12/26; H04L 29/06

(52) U.S. Cl. CPC A63F 13/71; H04L 63/0869; H04L 43/0852

(57) ABSTRACT

Systems and methods for secure computing and virtual environments are provided herein. An example method includes authenticating a client using social media credentials received from the client, evaluating authenticity of the client based on social network information obtained from a social network using the social media credentials, and securely communicate with the client over web service or web sockets using the social media credentials and a token checksum to facilitate an online endurance game.

### CROSS REFERENCE TO RELATED APPLICATIONS

This application claims the benefit and priority of U.S. Provisional Application Ser. No. 62/098,757, filed on Dec. 31, 2014, which is hereby incorporated by reference herein in its entirety including all references and appendices cited and incorporated therein.

### FIELD OF THE TECHNOLOGY

Embodiments of the disclosure relate to providing virtual environments in a secure and fraud protected manner, and more specifically, but not by limitation, to systems and methods that allow for users interact within a virtual environment in a secure and safe manner.

### SUMMARY

According to some embodiments, the present disclosure is directed to a system, comprising: (a) a memory for storing computer-executable instructions; and (b) a processor for executing computer-readable instructions to: (i) authenticate a client using social media credentials received from the client; (ii) evaluate authenticity of the client based on social network information obtained from a social network using the social media credentials; (iii) securely communicate with the client over web service or web sockets using the social media credentials and a token checksum to facilitate an online endurance game; (iv) eliminate a player of the online endurance game when the player's timer displays a time of zero; (v) identify a winner when only one player remains in the online endurance game; (vi) provide to the winner a quantity of prize tickets; and (vii) allow the winner to redeem the quantity of prize tickets for a prize.

According to some embodiments, the present disclosure is directed to a method, comprising: (a) authenticating a client using social media credentials received from the client; (b) securely communicating with the client over web service or web sockets using the social media credentials and a token checksum to facilitate an online endurance game; (c) providing the client with a graphical user interface that comprises an interactive object comprising an interactive player timer; (d) eliminating a player of the online endurance game when the interactive player timer displays a time of zero; (e) identifying a winner when only one player remains in the online endurance game; and (f) providing to the winner a quantity of prize tickets.

According to some embodiments, the present disclosure is directed to a system comprising: (a) server that facilitates an online endurance game that requires continuous or periodic player input to reset an interactive player timer, wherein a plurality of players compete to determine who is a last player, further wherein players of the plurality of players are eliminated when their interactive player timer has a time of zero; and (b) a peripheral device that is programmed with a security code that uniquely identifies a player, the peripheral device communicating with the server when the peripheral device couples with a client that is securely coupled with the server over a network connection, wherein the continuous or periodic player input is received by the peripheral device.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is an example computing architecture that is constructed in accordance with the present disclosure.

FIG. 2 is a screenshot of a graphical user interface illustrating an interactive input object and an interactive player timer.

FIG. 3 is a screenshot of a graphical user interface illustrating a last remaining player winning a prize.

FIG. 4 is a screenshot of a graphical user interface illustrating a plurality of game options for a player arranged into a game store page.

FIG. 5 is a screenshot of a wire frame illustrating a plurality of players in an online endurance game and player interactions and activities.

FIG. 6 is a flowchart of an example method of the present disclosure.

FIG. 7 illustrates an exemplary computing system that may be used to implement embodiments according to the present technology.

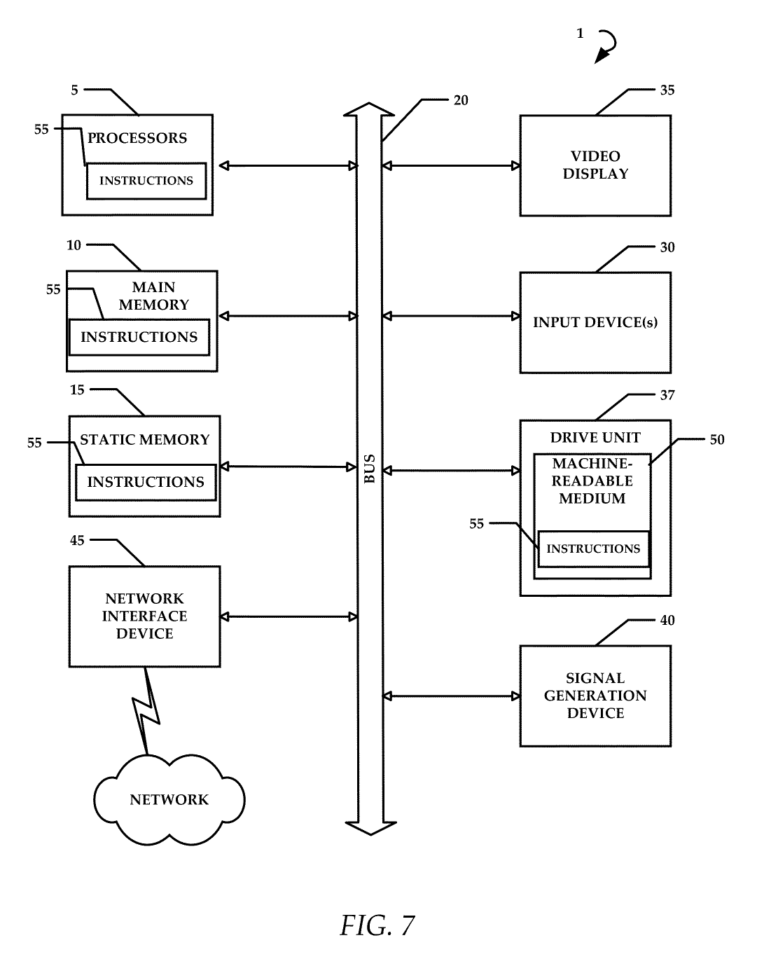

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

According to some embodiments, the present disclosure is directed to systems and methods of secure computing within the context of virtual environments such as computing games and contests. In some embodiments, the present disclosure includes a web based application which utilizes modern web technologies to provide a highly scalable, secure, real time gaming environment for any Internet connected device, referred to herein as a client.

Embodiments of the present disclosure are directed to systems and methods of implementing online multi-player endurance games where winners are awarded real-life prizes. The game may be integrated with a social networking platform to enable players to play with friends and family.

Some embodiments of the present disclosure are implemented using a PHP framework, custom REST API services, Web Sockets, JavaScript, HTML, CSS and other modern web programming technologies to provide core functionality.

In some embodiments, the present disclosure provides security features. For example, systems configured for use with the methods of the present disclosure utilize SSL encrypted communications between all client and server connections and/or transactions. The systems utilize a firewall with intrusion detection for preventing network intrusion.

In some embodiments, the systems implement fraud prevention algorithms which evaluate social network user information for authenticity.

The systems can also comprise a bot prevention system which utilizes a combination of a social network user authenticity algorithm and a challenge-response test.

In some embodiments, the systems integrate with a social network platform and utilize the user authentication process of the social network for player login and selection of game permissions.

According to some embodiments, encrypted social network identifiers and token checksum are used over web service and web sockets communications provided by the systems of the present disclosure.

Server and client architectures of the present disclosure employ secure web sockets over SSL/TLS and secure HTTP (HTTPS) over SSL/TLS.

In some embodiments, the systems of the present disclosure are configured to facilitate code management of network or device latency and potential fraud between client device and server. This can include measuring and comparing latency values to expected values or thresholds, in one embodiment.

According to some embodiments, each client connection establishes a secure socket connection directly to the server, which allows for secure real time game operation, latency management, and fraud prevention.

The architecture of these systems supports secure operation with Internet of Things (IoT), wired and wireless peripheral integration/input devices, Wearables, voice control & audible instruction, virtual and mixed reality communications, and operability including gesture input.

The present disclosure provides also for multi-player online games that allow players to utilize their social network to play with friends, friends of friends, and strangers. Players are allowed to earn in-game prizes by accomplishing particular in-game goals or by leveling up in the game. In-game prizes can assist players in their gameplay.

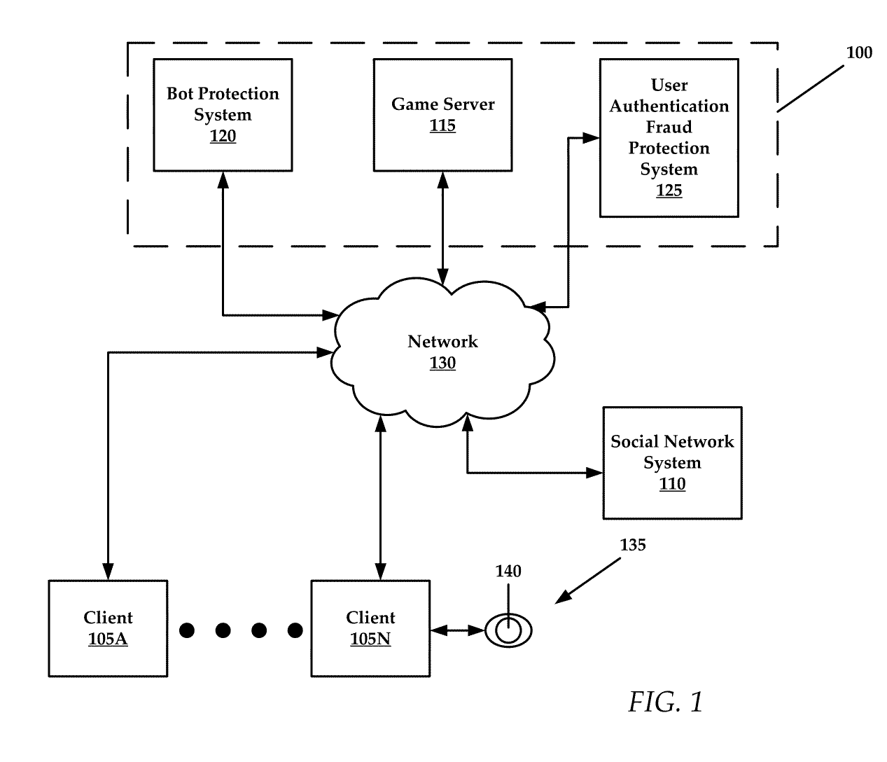

FIG. 1 illustrates an example system that includes a game system 100, clients 105A-N, and a social network system 110 or other third party service. The game system 100 provides secure and fraud protected secure computing and virtual environments, such as virtual endurance games. A plurality of players can utilize the clients 105A-N to play the endurance games, in some embodiments.

In one embodiment, the game system 100 comprises a game server 115 that provides endurance game features, a bot protection system 120 that provides protection from bot attacks, and a user authentication and fraud protection system 125. In some embodiments, these components of the game system 100 are arranged into a cloud-based computing environment. In general, a cloud-based computing environment is a resource that typically combines the computational power of a large grouping of processors, and/or an environment that combines the storage capacity of a large grouping of computer memories or storage devices. For example, systems that provide a cloud resource may be utilized exclusively by their owners; or such systems may be accessible to outside users who deploy applications within the computing infrastructure to obtain the benefit of large computational or storage resources.

The cloud may be formed, for example, by a network of web servers, such as web servers, with each web server (or at least a plurality thereof) providing processor and/or storage resources. These servers may manage workloads servicing multiple users (e.g., cloud resource customers or other users). Typically, each user places workload demands upon the cloud that vary in real-time, sometimes dramatically. The nature and extent of these variations typically depend on the type of business associated with the user, such as the facilitation of secure online gaming.

The clients 105A-N communicatively couple with the game system 100 over one or more network connections, such as network 130. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

According to some embodiments, clients 105A-N communicate with the game system 100 using secure web sockets over SSL/TLS and secure HTTP (HTTPS) over SSL/TLS. Also, each client 105A-N establishes a secure socket connection directly to the game system 100, which allows for secure real time game operation, latency management, and fraud prevention.

In general, systems of the present disclosure generally comprise at least a processor, a network interface, and a memory. According to some embodiments, the memory comprises logic (e.g., instructions) that can be executed by the processor to perform various methods, which are described in greater detail herein.

In some embodiments, the game server 115 is configured to authenticate a client, such as client 105A using social media credentials received from the client. In one embodiment, a player can provide their login credentials such as a username or password for a social network provided by the social network system 110. The user authentication, fraud protection system (referred to as “auth system 125”) can utilize the login credentials to log the player into their social media account provided by the social network system 110.

If the player is authenticated, the auth system 125 can evaluate authenticity of the client/player based on social network information obtained from a social network using the social media credentials. For example, the auth system 125 can verify a player's name, address, city, or other identifying information in order to verify the identity of the user. The auth system 125 utilizes a social network authenticity algorithm that generates a score or value for the authenticity of a player that can be used to determine if the player is authentic or potentially fraudulent. The score or value generated by the social network authenticity algorithm may be considered as an authenticity score.

In some embodiments, the auth system 125 can generate a token checksum for the player and this token checksum can be utilized to quickly permit communications and transmissions between the client and the game system 100.

That is, the game system 100 will securely communicate with the client over web service or web sockets using the social media credentials and a token checksum to facilitate an online endurance game. By way of example, the encrypted social network identifiers and token checksum are used over web service and web sockets communications provided by the game system 100.

In some embodiments, the bot protection system 120 can be employed to ensure that players and client systems are protected (as well as the game system) from malware and bot attacks utilizing both a social network authenticity algorithm and challenge-response functions.

Thus, the game system 100 can implement two factor authentication that includes authentication using the social media credentials and a challenge-response test to reduce malicious activity.

According to some embodiments, the game server 115 is configured to facilitate an online endurance game between a plurality of players. During gameplay, the auth system 125 is configured, in some embodiments, to implement network and client monitoring to determine if fraud, network exploitation, or malicious activities are occurring.

The auth system can monitor network latency, which includes traffic transmission rates on the network to determine if network segments are performing differently than other network segments. Anomalously high network traffic in one sector of the network may indicate malicious behavior occurring in that high traffic sector.

In one embodiment, the auth system 125 can compare any of the network latency and the client latency to latency thresholds. For example, if a network latency is expected to fall within a given range of latency values and the actual measured network latency is higher than the expected latency values, the auth system 125 can generate an alert for network administrators.

In another embodiment, the auth system 125 can flag the client or network for potential fraud when the any of the network latency and the client latency meet or exceed the latency thresholds.

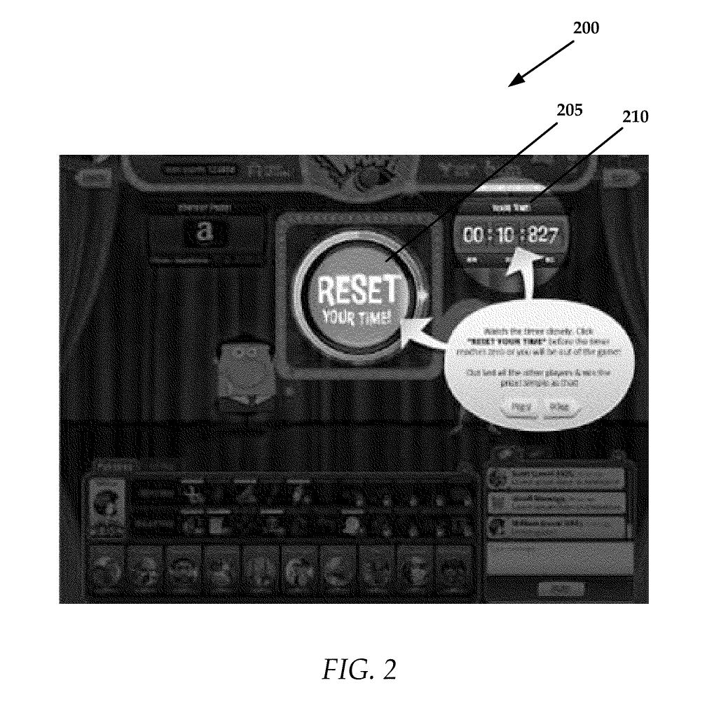

With respect to game play, the game system 115 can be configured to allow players to engage in an online endurance game. In the illustrated examples of FIGS. 2-5, the players can participate in an endurance game that requires the players to continually or periodically interact with an input object such as a button on a graphical user interface. In FIG. 2, the GUI 200 includes a reset button 205 that is coupled to an interactive player timer 210. The reset button 205 can be depressed periodically, in some embodiments, prior to expiration of time on the interactive player timer 210 to keep the player in the endurance game. Thus, the endurance aspect to the game involves requiring the player to remain present with the reset button 205, interacting with it as required. If the interactive player timer 210 expires the player is eliminated from the game.

The game system 110 is also configured to randomly alter an interactive time bar of a player to require the player to stay engaged with the game. For example, if the interactive timer for a player is at seven minutes, the game system 110 can selectively change the timer to thirty seconds remaining, which requires the player to interact with the reset button quickly or be eliminated. The game system 110 can randomly reset the interactive timer with a time value that may be greater or lesser than the current time value of the timer.

In one embodiment, the game system 100 will initiate an online endurance game after a predetermined number of clients are authenticated. A list of players is provided in a bottom ribbon of the GUI 200. Thus, the game server 115 is configured to eliminate a player of the online endurance game when an interactive player's timer displays a time of zero.

The game system 115 also identifies a winner when only one player remains in the online endurance game and provides to the winner a quantity of prize tickets or other prizes.

In other embodiments, rather than period user input, the game system 115 requires the player to continually depress the button 205 to stay present or active in the game. Thus, the game system 115 is configured to receive a continuous player input from the client to prevent the interactive player's timer from expiring.

According to some embodiments, the game server 115 is configured to randomly terminate the online endurance game. The winner can include a plurality of players that remain active in the online endurance game. Thus, a winner can include a plurality of players.

In some embodiments, the game server 115 is configured to activate live audio or video feeds of the client when a player input is received. Thus, when a player depresses their reset button or is required to continually depress their input mechanism the game server 115 can obtain the image or video of the player and broadcast that image or video out to other players. Thus, players can view other players' interactions in the game in real-time.

In one embodiment, the game server 115 can allow a player to transfer their game to another player. Thus, the game server 115 can receive a request to transfer the interactive player's timer to a second client from a first client. Next, the game server 115 can allow the second client to assume the interactive player's timer if the request is approved. This functionality can also allow a player to transfer their current game from a desktop client to a mobile client.

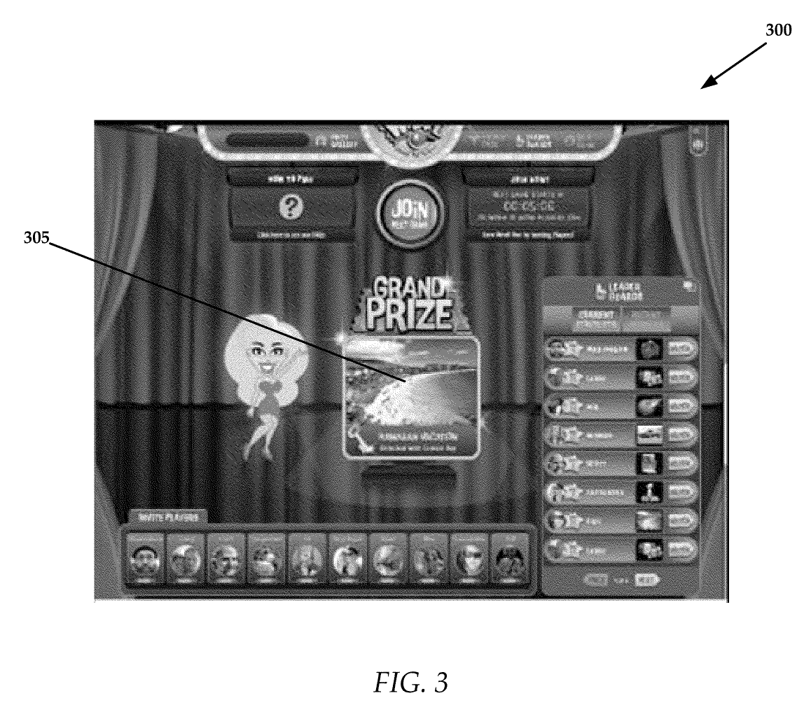

FIG. 3 illustrates a GUI 300 that includes a message 305 that the player has won a prize. With respect to prizes, the game server 115 can be configured to distribute prizes such as virtual prizes, tickets which can be redeemed for virtual prizes and/or physical prizes.

In some embodiments, the game server 115 can be configured to distribute tickets to losing parties as well. In one embodiment, a losing party is awarded a fraction of a single ticket for participating in the endurance game.

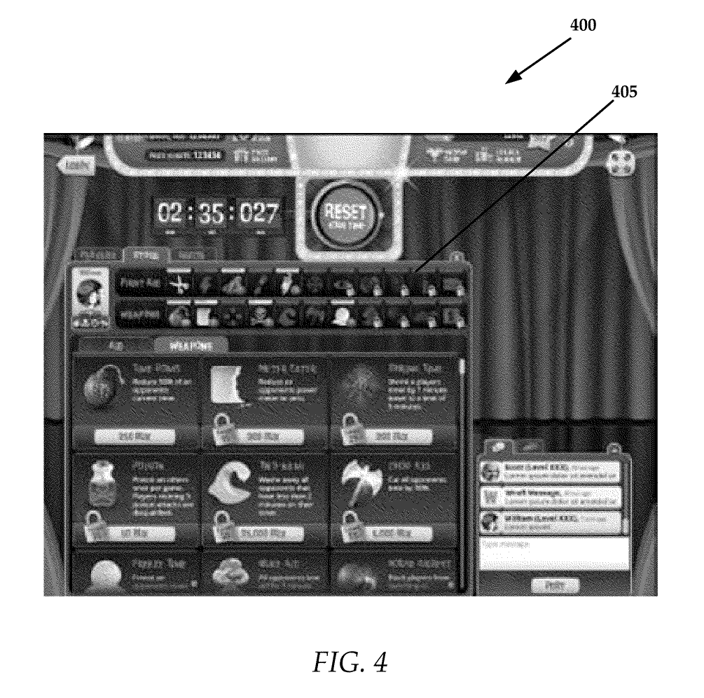

FIG. 4 illustrates a GUI 400 that includes a game store 405 where a player can purchase various features or options for the online game. Players can purchase interactive time bar altering options that can be executed against other players. The game system 110 is also configured to selectively allow a player to remove time from another player's interactive player timer using the features or options purchased from the store.

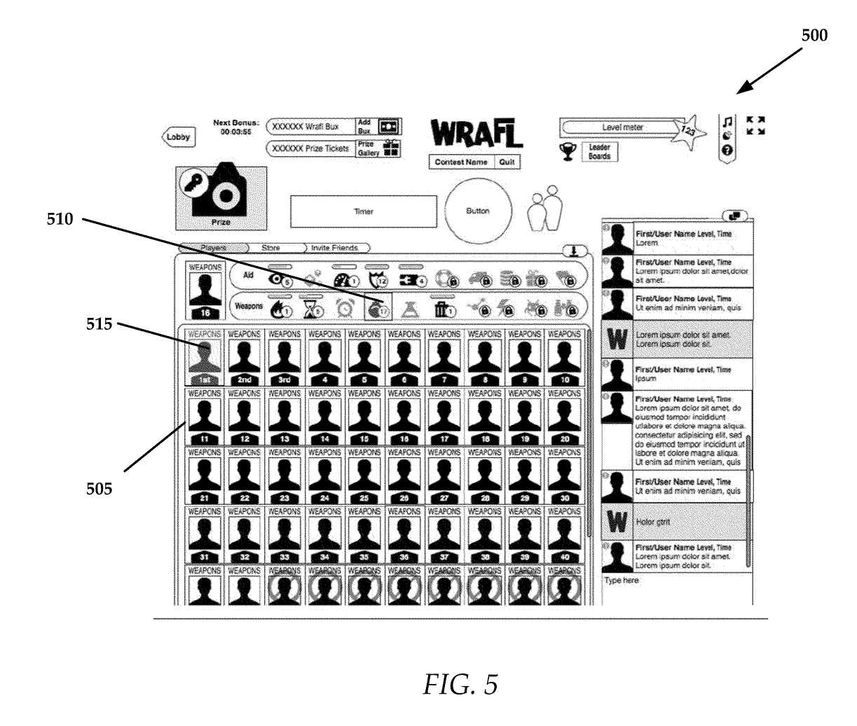

FIG. 5 illustrates a player matrix 505 and a player selection of a time bomb function 510. When a player 515 is selected the time bomb is executed against the player 515 to remove a portion of the time remaining on the player's timer.

Referring back to FIG. 1, in some embodiments the online endurance game is played using a peripheral device, such as a button peripheral 135. In one embodiment, the button peripheral 135 includes a depressible button 140. The button peripheral 135 (or any other peripheral configured for use with the systems and methods of the present disclosure) comprises memory that stores a token or other identifier that is used by the game server 115 to authenticate a player. For example, a player purchases a button peripheral 135 and the button peripheral 135 is assigned an identifier. When the player plugs in the button peripheral 135 into their client, the button peripheral 135 is identified by the game server 115 as an authenticated device. In some embodiments, the identifier of the button peripheral 135 is compared against the authenticated information of the player for additional security.

The button peripheral 135 comprises a light source, such as a LED light that can be illuminated by control of the game server 115. For example, the game server 115 can transmit a command to the client that is relayed to the button peripheral 135 that causes the button peripheral 135 to illuminate. When the button peripheral 135 illuminates, the player can be given a period of time to touch the depressible button 140 before the player is eliminated. Thus, in some embodiments, the interactive player timer is not required.

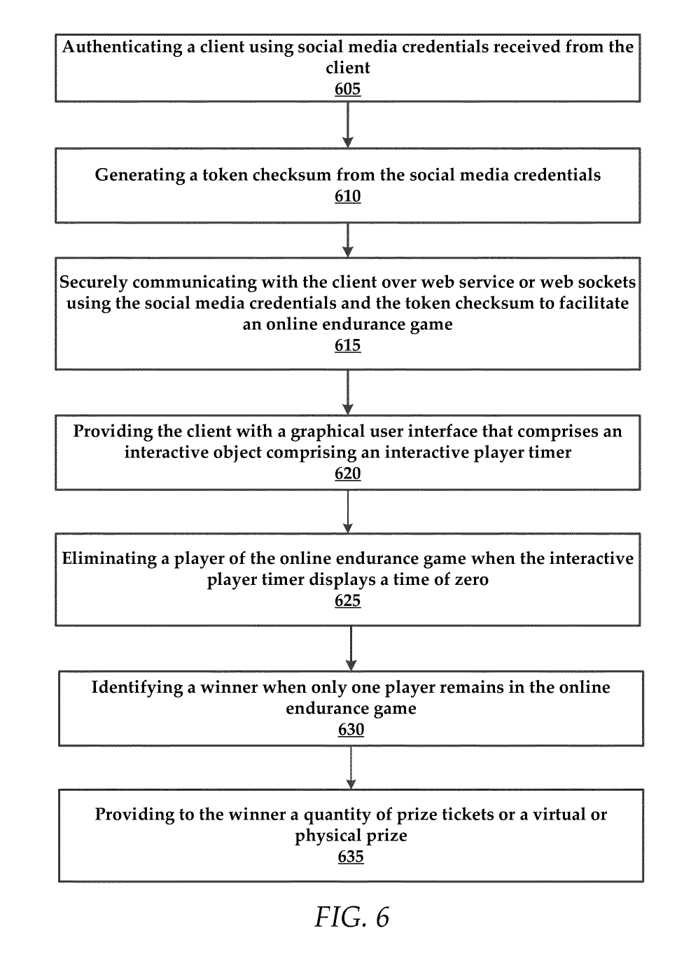

FIG. 6 illustrates a flow chart of an example method of the present disclosure. In one embodiment, the method includes authenticating 605 a client using social media credentials received from the client. In one embodiment, this can include a player providing login credentials for their social network account. The method can utilize a capture page that receives these credentials or a web form that directly logs the player into their social media account.

Once the game system logs the player into their social media account the game system can inspect their social media account for identifying information that is utilized to authenticate the identity of the player.

The method can include the system generating 610 a token checksum from the social media credentials.

After verifying the identity of the player, the method can include the game system securely communicating 615 with the client over web service or web sockets using the social media credentials and the token checksum to facilitate an online endurance game.

In some embodiments, the method includes providing 620 the client with a graphical user interface that comprises an interactive object comprising an interactive player timer. Examples of the interactive object include the reset button described above. In other embodiments, the method includes controlling a peripheral device, such as the button peripheral described above.

Next, the method includes the game system eliminating 625 a player of the online endurance game when the interactive player timer displays a time of zero and identifying 630 a winner when only one player remains in the online endurance game.

In one embodiment, the method includes providing 635 to the winner a quantity of prize tickets or a virtual or physical prize. It will be understood that not all steps illustrated in FIG. 6 are required in each embodiment. Various permutations and changes to the methods are contemplated and specifically those as claimed.

Additional advantages and embodiments are described in greater detail in the following paragraphs. In one embodiment, each contest starts either at a predetermined time or when a predetermined number of players have joined the contest. While players are waiting for a contest to start, they may have the option of playing waiting games, which could include monetization methods, such as completing surveys, watching videos, or signing up for trial offers.

In another embodiment, a timer is displayed on the game screen, and the time runs down as the contest progresses. When a player's time runs out, that player is eliminated from the contest. Thus, in order to win, a player must add time to his timer and outlast all other players. Players can add time to their timers by clicking a reset button on the game screen.

In some embodiments, a player would click the reset button once to add time to the timer, but, in other embodiments, the button could be pressed multiple times, held down for an indefinite period of time, or tapped at a certain rate or speed. The method of pressing the reset button may depend on the device the player is using.

The timer may periodically reset to a random time between ten seconds and ten minutes.

Players may refer friends to play the game in order to gain time on the timer. For example, players may gain one minute on the timer for every friend they refer.

In some embodiments, the reset button becomes inoperable for thirty seconds if the player presses the button too frequently.

The game may include a “sudden death” mode in which the game timer disappears, a game buzzer is activated, and the player has five seconds to press the reset button to stay in the game. The “sudden death” mode could occur at random during the game.

In some embodiments, the game is a true endurance game where players touch a predefined area on the screen of a touch-screen device, such as a phone or tablet, and maintain contact for an indefinite period of time. As alternatives to touching the screen, players may also hold down a button, such as on a mouse or keyboard, or maintain contact with a fingerprint sensor. The player who holds down the button or maintains contact for the longest period of time wins the game. The object the player touches may be a digital representation of a prize.

Touching the screen or holding down the button may activate an option for a live audio or video feed that shows the player participating in the game. If the player lets go of the button or removes his or her finger from the screen, he or she is removed from the game.

Some embodiments of the game allow the player to send his or her game session to another player in his or her social network. The other player assumes the first player's game position for that game only.

In some embodiments, the game stops regardless of the number of players left in the game. When the game stops, prize tickets may be divided equally among the remaining players. For every player who gets disqualified prior to the end of the game, the pot of prize tickets may increase by a predetermined amount.

The game may include a “lightening round,” in which each player clicks the reset button as many times as possible. The player who clicks the most wins.

An accessory USB hardware device (e.g., peripheral device) may be used with the online game. The USB device may comprise a button that lights up to signal the player to press the button in order to stay in the game. For example, once the button lights up, the player may have a predefined period of time in which to press the button. The button may light up at random so the player may need to pay attention to the button in order to continue playing the game.

In other embodiments, a hardware remote controller can be purchased or a software remote controller may be downloaded and installed on the player's device to enable the player to operate the reset button from a different device or to switch to a different device.

Players could earn in-game currency that would allow them to purchase in-game items. Players earn in-game currency by leveling up, winning in-game prizes, or engaging in various in-game activities. In some embodiments, these in-game activities include inviting friends to join the game or posting to social networking sites. In other embodiments, in-game currency can be purchased with real money.

An in-game currency vault may contain a fixed amount of in-game currency. In-game currency distributed to players is deducted from the amount contained in the vault, and in-game currency spent by players is added to the amount contained in the vault. This allows the game hosting site to monitor and track the flow of in-game currency. The game hosting site may adjust the characteristics of the in-game currency system based on the information from the monitoring and tracking. For example, the flow of in-game currency may alert the game hosting site that players are not using in-game currency or that the game is giving away too much in-game currency.

After a certain period of inactivity, for example thirty days, players may be notified via email that their in-game currency will expire if they do not play any games. If a player does not return after a fixed period of time after the notice is sent, for example, if the player does not return within thirty days of the notice, the player's in-game currency may be reclaimed and returned to the in-game currency vault.

On certain days, for example holidays, the game may provide an additional multiplier for the in-game currency earned or for achievements.

Players may purchase in-game items with in-game currency. Some in-game items enable players to attack other players. For example, players can use a “time bomb” to reduce an opponent's time by 50%. Other in-game items enable players to defend themselves from an opponent's attack. For example, a “defuse kit” protects a player from a “time bomb” attack. The number and types of in-game items that are available for purchase by a player increase as the player levels up in the game. Thus, additional in-game items are unlocked as a player levels up. In-game items may be purchased with real money as well as in-game currency.

In some embodiments, the frequency with which a player may use an in-game item is limited. Thus, once an item has been used, the item must “recharge” before it can be used again. The recharge level of each item is displayed on the game interface.

As the game progresses, players may earn trophies. Trophies are awarded when the player has accomplished certain in-game achievements, such as accumulating a certain amount of game time or making a certain number of game-related posts to a social networking site. Each trophy is accompanied by an award of a certain quantity of in-game currency.

Players may also use in-game currency to purchase in-game items to give to other players as gifts. Such items may include beer, coffee, flowers, violins, cigars, signs, balloons, hearts, kisses, and boxes of chocolates, among others. These gift items can be used to promote social interactions among players.

During holidays and other designated time periods, unique in-game items may be available for purchase as gifts. For example, diamond rings may be available for purchase with in-game currency. Players can purchase such unique items as gifts to impress other players.

Players may be able to post gifts to their profiles on social networking sites. In some embodiments, gifts are kept within a player's profile or inventory, for example, under a tab entitled gifts.

In one embodiment, an in-game chat screen allows players to chat with other players during the contest. The chat screen displays system messages that apprise players of occurrences in the contest, such as “Player C has been eliminated” or “Player A just bombed Player B,” as well as user messages from one player to another. Players may set the chat screen to display system messages only or both system messages and user messages.

Contest winners are awarded prize tickets that can be redeemed for real-life prizes. Players can view available prizes in the prize gallery and redeem prize tickets for a prize of their choice. Alternatively, winners may choose to save up prize tickets for a larger prize.

The number of prize tickets that can be won may get progressively larger as more players join the game or as the contest continues for a longer period of time.

In some embodiments, players have the option of exchanging a certain number of tickets for a hidden prize that could be more or less valuable than the tickets exchanged.

On certain days, such as holidays, prizes may be wrapped with a price value tag on the graphic. Players may spend in-game currency to unwrap the prizes.

In some embodiments, sponsored contests may be held. The prize of a sponsored contest is a single unique item that is not available in the prize gallery. Such a sponsored prize is only available to the winner of the specific sponsored contest.

The sponsored contest may comprise a game that is themed around a sponsor's brand or product where the themes of graphics and marketing materials are based on the sponsor's brand.

In one embodiment, each player receives one daily spin game every twenty-four hours. The daily spin game provides each player with the opportunity to win in-game currency at no cost to the player.

Some embodiments of the game feature random opportunities for players to earn in-game currency or special items. For example, at random times, a game show host may float up the game screen holding a balloon containing in-game currency or a special item. If the player clicks the balloon before the host reaches the top of the screen, the balloon pops, the host falls, and the player receives the in-game currency or special item.

Players may opt to spectate a contest without participating in it or spectate a contest from which the player has been eliminated.

In some embodiments, monetization methods are employed during a contest to provide the game-hosting site with additional income. Participation in monetization activities is optional for the player, and monetization activities may appear as mini games, side tabs, or pop-ups on the screen.

In other embodiments, the screen of the player's device displays video ads throughout the game, for example, in between button resets and item notifications.

During game play, a captcha or graphic display may appear, prompting players to input the correct characters on the screen to prove that the player is a human player and not a bot.

Some embodiments may include a live-feed API that provides leaderboard statistics for things such as, but not limited to, live events, remote devices, and sponsored contests.

As used herein, the term “engine”, “system”, “client”, “module”, “controller”, or “application” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

FIG. 5 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally and interchangeably used with its non-hyphenated version (e.g., “on demand”), and a capitalized entry (e.g., “Software”) may be interchangeably used with its non-capitalized version (e.g., “software”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected,” “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A system, comprising:
a memory for storing computer-executable instructions; and
a processor for executing computer-readable instructions to:
authenticate a client using social media credentials received from the client;
evaluate authenticity of the client based on social network information obtained from a social network using the social media credentials;
securely communicate with the client over web service or web sockets using the social media credentials and a token checksum to facilitate an online endurance game;
eliminate a player of the online endurance game when an interactive player's timer displays a time of zero;
identify a winner when only one player remains in the online endurance game;
provide to the winner a quantity of prize tickets; and
allow the winner to redeem the quantity of prize tickets for a prize.

2. The system according to claim 1, further comprising implementing two factor authentication that comprises both authentication using the social media credentials and a challenge-response test to reduce malicious activity.

3. The system according to claim 1, wherein the system is coupled with the client over a network and the system is further configured to:
monitor network latency and client latency;
compare any of the network latency and the client latency to latency thresholds; and
flag the client or network for potential fraud when the any of the network latency and the client latency meet or exceed the latency thresholds.

4. The system according to claim 1, wherein the system couples with the client over a direct secure socket connection.

5. The system according to claim 1, wherein the system initiates the online endurance game after a predetermined number of clients are authenticated, the predetermined number of clients comprising the client.

6. The system according to claim 1, wherein the system receives player input from the client to reset the interactive player's timer.

7. The system according to claim 1, wherein the system receives a continuous player input from the client to prevent the interactive player's timer from expiring.

8. The system according to claim 1, wherein the system periodically resets the player's timer with a random time value.

9. The system according to claim 1, wherein the system activates live audio or video feeds of the client when a player input is received.

10. The system according to claim 1, wherein the system is configured to:
receive a request to transfer the interactive player's timer to a second client; and
allowing the second client to assume the interactive player's timer.

11. The system according to claim 1, wherein the system is configured to randomly terminate the online endurance game, wherein the winner comprises a plurality of players that remain active in the online endurance game.

12. The system according to claim 11, wherein the system is configured to divide the quantity of prize tickets between the plurality of players.

13. A method, comprising:
authenticating a client using social media credentials received from the client;
securely communicating with the client over web service or web sockets using the social media credentials and a token checksum to facilitate an online endurance game;
providing the client with a graphical user interface that comprises an interactive object comprising an interactive player timer;
eliminating a player of the online endurance game when the interactive player timer displays a time of zero;
identifying a winner when only one player remains in the online endurance game; and
providing to the winner a quantity of prize tickets.

14. The method according to claim 13, further comprising evaluating authenticity of the client based on social network information obtained from a social network using the social media credentials.

15. The method according to claim 13, wherein the player timer displays a time of zero when the player fails to interact with the interactive player timer during a countdown period.

16. The method according to claim 13, further comprising selectively allowing a first player to remove time from another player's interactive player timer.

17. A system, comprising:
a server that facilitates an online endurance game that requires continuous or periodic player input to reset an interactive player timer, wherein a plurality of players compete to determine who is a last player, further wherein players of the plurality of players are eliminated when their interactive player timer has a time of zero; and
a peripheral device that is programmed with a security code that uniquely identifies a player, the peripheral device communicating with the server when the peripheral device couples with a client that is securely coupled with the server over a network connection, wherein the continuous or periodic player input is received by the peripheral device.

18. The system according to claim 17, wherein the peripheral device comprises a button.

19. The system according to claim 18, wherein the server is configured to selectively illuminate a light of the peripheral device, further wherein a player is required to depress the button within a time period after illumination of the light to remain active in the online endurance game.

20. The system according to claim 17, wherein the server is configured to activate a camera on the client to capture video or images of a player when the continuous or periodic player input is received.
